(19) United States
(12) Patent Application Publication
(10) Pub. No.: US 2026/0219154 A1
(43) Pub. Date: Jul. 30, 2026

(54) EQUIPMENT FOR CALIBRATING PARTICLE COUNT MEASUREMENT DEVICE, CALIBRATION PROGRAM, METHOD FOR DETERMINING PARTICLE SIZE FOR CALIBRATION, AND METHOD FOR CALIBRATING PARTICLE COUNT MEASUREMENT DEVICE

(71) Applicants: NATIONAL INSTITUTE OF ADVANCED INDUSTRIAL SCIENCE AND TECHNOLOGY, Chiyoda-ku, Tokyo (JP); HORIBA, Ltd., Kyoto-shi, Kyoto (JP)

(72) Inventors: Kentarou KOJIMA, Tsukuba-shi (JP); Yoshiko MURASHIMA, Tsukuba-shi (JP); Hiromu SAKURAI, Tsukuba-shi (JP)

(21) Appl. No.: 19/141,280

(22) PCT Filed: Dec. 14, 2023
(86) PCT No.: PCT/JP2023/044809

§ 371 Date: Jun. 19, 2025

(30) Foreign Application Priority Data
Dec. 21, 2022 (JP) 2022-203992
Jan. 26, 2023 (JP) 2023-010372

(51) Int. Cl. G01N 15/10

(52) U.S. Cl. CPC G01N 15/1012; G01N 2015/1014; G01N 2015/1028; G01N 2015/1029

(57) ABSTRACT

Equipment for calibrating a particle count measurement device, a calibration program, a method for determining particle size for calibration, and a method for calibrating a particle count measurement device can reduce the effect of a post-classification particle size change and perform more accurate calibration. The calibration equipment is provided with: a particle generation unit; an input unit; a particle classification unit; a particle-sensing unit; a computation unit that obtains a degree of change by which the size of particles arriving at the particle-sensing unit has changed from a target size, and thereby calculates, a corrective amount for the particle size extracted by the particle classification unit such that the particle size matches the target particle size; and a correction command unit for issuing, a command to the particle classification unit to change the size of the particles extracted by the particle classification unit to a particle size for calibration.

### TECHNICAL FIELD

The present disclosure relates to a calibration apparatus and a calibration program for a particle number measurement device, a method of determining a calibration particle size, and a method of calibrating a particle number measurement device.

### BACKGROUND ART

In recent years, in order to enhance the cleanliness of automobile exhaust gas, the importance of counting particles of so-called nanoparticle size contained in exhaust gas has increased, which are smaller in size than conventional particles. For the measurement of such particles of nanoparticle size, particle number measurement devices, such as a Condensation Particle Counter (CPC), are used. In order to accurately count fine particles using a particle number measurement device, appropriate calibration of the particle number measurement device is required. Conventionally, calibration of a particle number measurement device has been executed by using a particle generator that generates particles as droplets, and a particle classifier that classifies the particles generated by the particle generator, followed by counting particles of a predetermined particle size.

Meanwhile, Patent Document 1 discloses that evaporation occurs in liquid particles, causing changes in particle size of the liquid particles. Patent Document 2 discloses that the counting efficiency of a condensation particle counter varies depending on particle sizes.

### CITATION LIST

### Patent Document

Patent Document 1: Japanese Unexamined Patent Application, Publication No. 2008-185559
Patent Document 2: Japanese Examined Patent Application Publication No. H07-104259

### DISCLOSURE OF THE INVENTION

### Problems to be Solved by the Invention

However, in conventional calibration apparatuses and calibration methods for a particle number measurement device using a particle classifier, calibration has been based on the assumption that the particle classifier extracts particles of a desired particle size, in which no consideration has been given to the potential changes that may occur in particle sizes of the particles classified and extracted by the particle classifier.

An object of the present disclosure is to provide a calibration apparatus and a calibration program for a particle number measurement device, a method of determining a calibration particle size, and a method of calibrating a particle number measurement device, which are capable of more accurate calibration by reducing the influence of changes in particle size after classification.

### Means for Solving the Problems

The present disclosure solves the above problem by the following means. In order to facilitate understanding, reference numerals corresponding to embodiments of the present disclosure are included in the description; however, the present disclosure is not limited thereto.

A first disclosure provides a calibration apparatus (1, 1B) for use in calibrating a particle number measurement device (31), in which the apparatus includes: a particle generation unit (10) configured to generate particles; an input unit (51) configured to receive an input of a target particle size; a particle classification unit (20) configured to classify the particles generated by the particle generation unit (10) and extract particles corresponding to the target particle size received via the input unit (51); a particle detection unit (30) configured to detect the particles extracted by the particle classification unit (20) ; a calculation unit (52) configured to determine a degree of change in particle size relative to the target particle size for each of the particles that have reached the particle detection unit (30), based on a physical quantity factor for a change in particle size at the particle detection unit (30), or a particle size distribution of the particles at the particle detection unit (30), and to calculate a correction amount for particle sizes of particles to be extracted by the particle classification unit (20), such that the particle sizes of the particles reaching the particle detection unit (30) match the target particle size; and a correction instruction unit (53) configured to instruct the particle classification unit (20) to change the particle sizes of the particles to be extracted by the particle classification unit (20) into a calibration particle size, based on the correction amount calculated by the calculation unit (52).

A second disclosure provides the calibration apparatus (1, 1B) for a particle number measurement device (31) as described in the first disclosure, in which the apparatus further includes: a physical quantity factor detection unit (40) configured to detect the physical quantity factor, in which the calculation unit (52) is configured to calculate the correction amount using at least the physical quantity factor obtained by the physical quantity factor detection unit (40).

A third disclosure provides the calibration apparatus (1, 1B) for a particle number measurement device (31) as described in the first disclosure, in which the particle detection unit (30) includes a particle size distribution measurement unit (33) configured to detect a particle size distribution of the particles reaching the particle detection unit (30) and the calculation unit (52) is configured to calculate the correction amount using the particle size distribution detected by the particle size distribution measurement unit (33).

A fourth disclosure provides the calibration apparatus (1, 1B) for a particle number measurement device (31) as described in the first or second disclosure, in which the physical quantity factor includes at least one of a temperature, humidity, pressure, flow rate, or residence time of a fluid in a flow path from the particle classification unit (20) to the particle detection unit (30).

A fifth disclosure provides the calibration apparatus (1) for a particle number measurement device (31) as described in the third disclosure, in which the particle size distribution measurement unit (33) includes: a second particle classification unit (34) configured to classify the particles reaching the particle size distribution measurement unit (33); and a particle counting unit (35) configured to connect downstream of the second particle classification unit (34) and count a particle number of the particles classified by the second particle classification unit (34).

A sixth disclosure provides the calibration apparatus (1) for a particle number measurement device (31) as described in the third or fifth disclosure, in which the input unit (51) is configured to receive a function representing a detection efficiency per particle size for the particle number measurement device (31) serving as a calibration target, and the calculation unit (52) is configured to calculate a detection efficiency at the target particle size achieved by the particle number measurement device (31) serving as a calibration target, using the particle size distribution detected by the particle size distribution measurement unit (33).

A seventh disclosure provides the calibration apparatus (1, 1B) for a particle number measurement device (31) as described in any one of the first to sixth disclosures, in which the correction instruction unit (53) is configured to instruct the particle classification unit (20) to change a voltage applied to a classification tube provided in the particle classification unit (20).

An eighth disclosure provides the calibration apparatus (1, 1B) for a particle number measurement device (31) as described in any one of the first to seventh disclosures, in which the particles generated by the particle generation unit (10) contain poly alpha-olefin as a main component; and a solvent used for diluting the poly alpha-olefin has an ethanol content of 50% or more by weight.

A ninth disclosure provides the calibration apparatus (1, 1B) for a particle number measurement device (31) as described in any one of the first to eighth disclosures, in which a flow path from particle generation unit (10) to the particle classification unit (20) is an evaporation flow path, where component evaporation from a particle surface occurs in advance, such that a rate of reduction in particle size due to the component evaporation from the particle surface is less than 3% in a flow path from the particle classification unit (20) to the particle detection unit (30).

A tenth disclosure provides a calibration program for use in calibrating a particle number measurement device (31), in which the program causes a computer (50) to execute the steps of: causing a particle generation unit (10) to generate particles; causing an input unit (51) to receive an input of a target particle size from a user; causing a particle classification unit (20) to classify the particles generated by the particle generation unit (10) and extract particles corresponding to the target particle size received via the input unit (51) ; detecting, by a particle detection unit (30), the particles extracted by the particle classification unit (20); causing a calculation unit (52) to determine a degree of change in particle size relative to the target particle size for each of the particles that have reached the particle detection unit (30), based on a physical quantity factor for a change in particle size at the particle detection unit (30), or a particle size distribution of the particles at the particle detection unit (30), and calculate a correction amount for particle sizes of particles to be extracted by the particle classification unit (20), such that the particle sizes of the particles reaching the particle detection unit (30) match the target particle size; and causing a correction instruction unit (53) to instruct the particle classification unit (20) to change the particle sizes of the particles to be extracted by the particle classification unit (20) into a calibration particle size, based on the correction amount calculated by the calculation unit (52).

An eleventh disclosure provides the calibration program as described in the tenth disclosure, in which the program further includes the step of causing a physical quantity factor detection unit (40) to detect the physical quantity factor, in which the calculation unit (52) is configured to calculate the correction amount using at least the physical quantity factor obtained by the physical quantity factor detection unit (40).

A twelfth disclosure provides the calibration program as described in the tenth disclosure, in which the program further includes the step f causing a particle size distribution measurement unit (33) to detect a particle size distribution of the particles reaching the particle detection unit (30), in which the calculation unit (52) is configured to calculate the correction amount using the particle size distribution detected by the particle size distribution measurement unit (33).

A thirteenth disclosure provides a method of determining a calibration particle size for use in calibrating a particle number measurement device (31), in which the method includes the steps of: causing a particle generation unit (10) to generate particles; causing an input unit (51) to receive an input of a target particle size from a user; causing a particle classification unit (20) to classify the particles generated by the particle generation unit (10) and extract particles corresponding to the target particle size received via the input unit (51); causing a particle detection unit (30) to detect the particles extracted by the particle classification unit (20); causing a calculation unit (52) to determine a degree of change in particle size relative to the target particle size for each of the particles that have reached the particle detection unit (30), based on a physical quantity factor for a change in particle size at the particle detection unit (30), or a particle size distribution of the particles at the particle detection unit (30), and calculate a correction amount for particle sizes of particles to be extracted by the particle classification unit (20), such that the particle sizes of the particles reaching the particle detection unit (30) match the target particle size; and causing a correction instruction unit (53) to instruct the particle classification unit (20) to change the particle sizes of the particles to be extracted by the particle classification unit (20) into a calibration particle size, based on the correction amount calculated by the calculation unit (52).

A fourteenth disclosure provides the method of determining a calibration particle size as described in the thirteenth disclosure, in which the method further includes the step of causing a physical quantity factor detection unit (40) to detect the physical quantity factor, in which the calculation unit (52) is configured to calculate the correction amount using at least the physical quantity factor obtained by the physical quantity factor detection unit (40).

A fifteenth disclosure provides the method of determining a calibration particle size as described in the thirteenth disclosure, in which the method further includes the step of causing a particle size distribution measurement unit (33) to detect a particle size distribution of the particles reaching the particle detection unit (30), in which the calculation unit (52) is configured to calculate the correction amount using the particle size distribution detected by the particle size distribution measurement unit (33).

A sixteenth disclosure provides a method of calibrating a particle number measurement device (31), in which the method includes: causing the particle classification unit (20) to extract particles based on the calibration particle size determined by the method of determining a calibration particle size as described in any one of the thirteenth to fifteenth disclosures; and calibrating the particle number measurement device (31) serving as a calibration target using the particles of the calibration particle size extracted by the particle classification unit (20).

### Effects of the Invention

According to the present disclosure, it is possible to provide a calibration apparatus for a particle number measurement device, a calibration program, a method of determining a calibration particle size, and a method of calibrating a particle number measurement device, all of which enable more accurate calibration by reducing the influence of changes in particle size after classification.

### BRIEF DESCRIPTION OF THE DRAWINGS

FIG. 1 is a block diagram illustrating the configuration of a calibration apparatus 1 for a particle number measurement device according to a first embodiment;

FIG. 2 is a graph illustrating an example of a detection efficiency function that indicates the detection efficiency of a particle number measurement device 31 for each particle size;

FIG. 3 is a table summarizing the configuration of a flow path F1 before classification and a flow path F4 after classification, which were used in an experiment to investigate the relationship between the residence time of particles in the flow path and particle shrinkage;

FIG. 4 is a graph plotting the effect of post-classification residence time on particle sizes of particles reaching a particle detection unit 30, for each pre-classification residence time;

FIG. 5 is a graph illustrating the effect of pre-classification residence time on the shrinkage rate;

FIG. 6 is a flowchart illustrating an operational flow when executing a method of determining and calibrating a calibration particle size, primarily executed by a control unit 50;

FIG. 7 is a graph summarizing a detection efficiency determined for each particle size in both an Example and a Comparative Example;

FIG. 8 is a graph plotting the results obtained by calculating a particle size change ΔDp (nm) due to evaporation as the difference between a classified particle size and a measured particle size, for each measured particle size;

FIG. 9 is a table illustrating the difference in detection efficiency between the Comparative Example and the Example at a particle size of 10 nm;

FIG. 10 is a table illustrating the difference in detection efficiency between the Comparative Example and the Example at a particle size of 15 nm; and

FIG. 11 is a block diagram illustrating the configuration of a calibration apparatus 1B for a particle number measurement device according to a second embodiment.

### PREFERRED MODE FOR CARRYING OUT THE INVENTION

Hereinafter, one embodiment for implementing the present disclosure will be described with reference to the drawings.

### First Embodiment

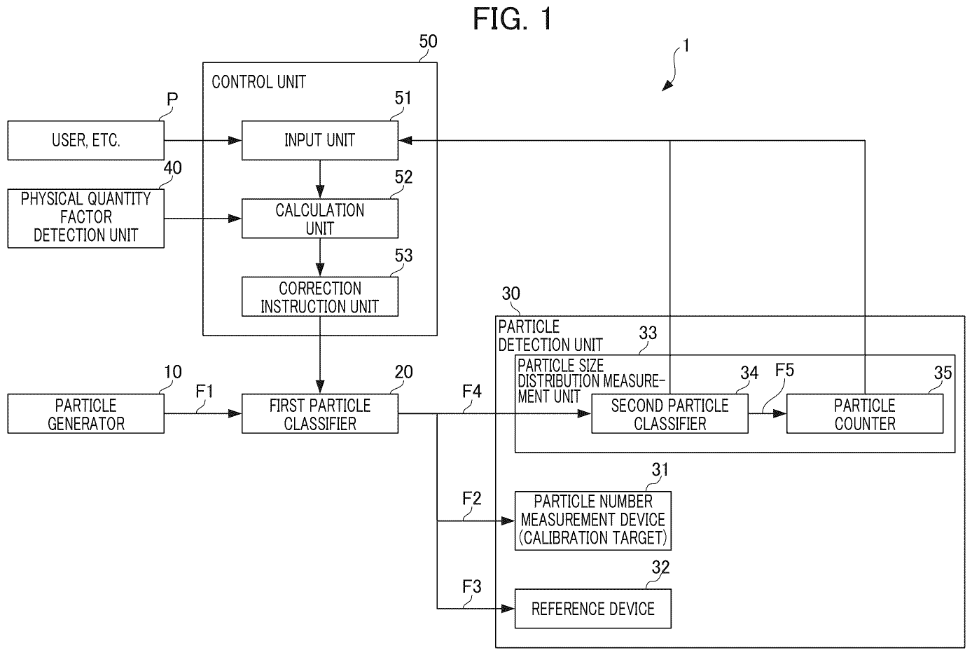

FIG. 1 is a block diagram illustrating the configuration of a calibration apparatus 1 for a particle number measurement device according to the first embodiment. The drawings, including FIG. 1 and those described below, are schematic diagrams, in which the sizes and shapes of individual components are exaggerated or omitted as appropriate to facilitate understanding. In the following description, specific numerical values, shapes, materials, and other details are provided for illustrative purposes and may be modified as necessary.

calibration apparatus 1 for a particle number measurement device includes a particle generator 10, a first particle classifier 20, a particle detection unit 30, a physical quantity factor detection unit 40, and a control unit 50. The calibration apparatus 1 is used for calibrating a particle number measurement device 31 as a calibration target.

The particle generator (particle generation unit) 10 is an electrospray device configured to generate a large number of liquid particles. In the present embodiment, the particles generated by the particle generator 10 are composed of a material generally referred to as poly alpha-olefin (PAO). The particle generator 10 of the present embodiment uses the poly alpha-olefin diluted in a solvent mainly composed of ethanol. The solvent used for diluting poly alpha-olefin is an organic solvent containing a lower alcohol, and preferably contains at least 50% ethanol by weight, more preferably at least 75% ethanol by weight, and ideally 100% ethanol by weight. The solvent may also contain, for example, toluene in addition to lower alcohols. In the present embodiment, the solvent used for diluting poly alpha-olefin consists of 100% ethanol by weight. As the solvent, for example, a mixture of ethanol and isopropyl alcohol may also be used. Since ethanol has high polarity, increasing the ethanol ratio allows for increasing the number of particles generated by the particle generator 10. In order to increase the number of particles generated by the particle generator 10, the amount of electrolyte contained in the solvent may be increased.

The first particle classifier (particle classification unit) 20 classifies the particles generated by the particle generator 10, and extracts particles corresponding to the target particle size received via an input unit (described later), then discharges the extracted particles downstream. The first particle classifier 20 employs a Differential Mobility Analyzer (DMA). The first particle classifier 20 includes a classification tube with a dual-cylinder structure that functions as an electrode, and only the particles of a particle size corresponding to the voltage applied to this classification tube are extracted (classified) by the first particle classifier 20. Accordingly, the first particle classifier 20 can extract particles of various particle sizes by changing the voltage applied to the classification tube.

The particle detection unit 30 includes a detector configured to detect the particles classified and extracted by the first particle classifier 20. The particle detection unit 30 is provided at a position where the particle number measurement device 31 serving as a calibration target can be installed. Here, “a position where the particle number measurement device 31 can be installed” may either mean a position where the particle number measurement device 31 is installed, or a position where the particle number measurement device 31 is not installed but can be installed. This also includes a configuration in which the particle number measurement device 31 and a particle size distribution measurement unit 33 (described later) are interchangeably arranged. Here, in order to facilitate understanding, the particle number measurement device 31 and the particle size distribution measurement unit 33 are described as being provided together instead of interchangeably. The particle detection unit 30 in the present embodiment includes the particle number measurement device 31, a reference device 32, and the particle size distribution measurement unit 33.

The particle number measurement device 31 is a condensation particle counter (CPC) serving as a calibration target to be calibrated by the calibration apparatus 1 in the present embodiment. The particle number measurement device 31 is used for particle measurement to confirm that harmful particles in exhaust gas are within regulatory limits at locations such as automobile manufacturing plants, inspection agencies, and research institutions. The particle number measurement device 31 can directly or indirectly measure exhaust gas particles. In order to enable the particle number measurement device 31 to execute accurate measurements, calibration operations use the calibration apparatus 1 of the present embodiment. The particle number measurement device 31 is also capable of measuring particles generated from vehicle brakes (brake dust), particles generated from tires (tire dust), particles contained in exhaust gas from factories, and particles present in the atmosphere.

The reference device 32 measures the number of particles serving as the reference. The reference device 32 may use, for example, an electrometer. An electrometer can count the number of uniformly charged particles by measuring the current regardless of particle sizes, thus can obtain a particle number serving as the reference for calibrating the particle number measurement device 31. However, the electrometer is not suitable for counting particles that have not undergone a charging process, such as particles of a target particle size contained in exhaust gas. The calibration apparatus 1 of the present embodiment includes the first particle classifier 20 including an electrical charge neutralizer on the upstream side, thus can accurately count only the singly charged particles of the target particle size. The reference device 32 may use not only an electrometer but also a CPC with higher accuracy than the CPC serving as the calibration target.

The particle generator 10, the first particle classifier 20, the particle number measurement device 31, and the reference device 32 described above are similar to those used in conventional calibration apparatuses, and calibration operations of the particle number measurement device 31 were conventionally executed using such a configuration. However, in recent years, the measurement of exhaust gas is required to count the number of particles contained in exhaust gas at a so-called nanoparticle level, which are smaller in particle size than conventional particles. The research conducted by the present applicant has revealed that the changes in particle size of particles classified and extracted by the particle classifier affect the calibration accuracy when targeting the particles at a nanoparticle level. The changes in particle size of the particles classified and extracted by the particle classifier have not been considered in conventional calibration operations. It is considered that since the target particle size has been relatively large in conventional cases, the impact on calibration accuracy should have been small enough to be negligible. However, in the calibration of a particle number measurement device that measures extremely fine particles, such as particles of a particle size of 15 nm or smaller, and particularly particles of a particle size of 10 nm or smaller, it has been found that the changes in particle size of the particles classified and extracted by classifier a significant factor affecting calibration accuracy.

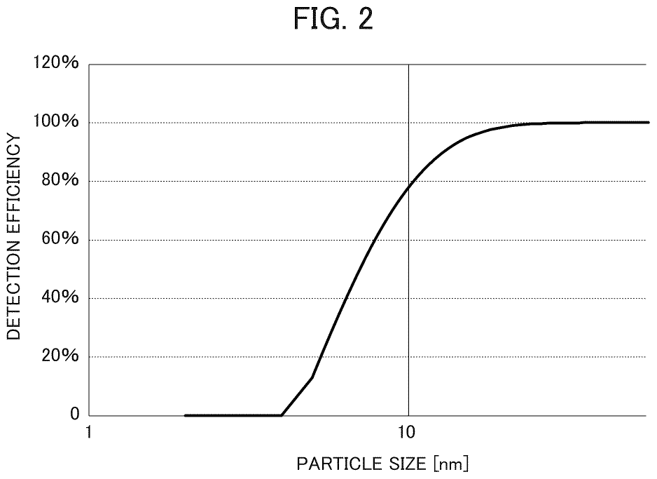

The particle generator 10 has conventionally been used for calibration operations, and is similarly used in the present embodiment. The particle generator 10 employs an electrospray technique to generate liquid particles to be used for calibration. However, due to using the liquid particles, liquid components of the liquid particles continuously are evaporating immediately after generation, causing gradual reductions in particle size of the liquid particles. FIG. 2 is a graph illustrating an example of a detection efficiency function that indicates the detection efficiency of the particle number measurement device 31 for each particle size. As can be understood from the relationship between particle size and detection efficiency illustrated in FIG. 2, the detection efficiency of the particle number measurement device is stable at approximately 100% in a region with larger particle sizes (plateau region), regardless of changes in particle size. In contrast, the particle number measurement device includes a region with smaller particle sizes (cut-off region), in which the detection efficiency significantly decreases, and even slight changes in particle size in the cut-off region cause significant changes in the detection efficiency. In conventional particle number measurement devices with a cut-off region located in a relatively large particle size range (e.g., a range where the particle size is greater than a predetermined value, such as 15 nm), the reduction in particle size, from the particle generator to the particle number measurement device, has been minimal to have little effect on measurement results. However, in a range where the particle size is relatively smaller than conventional cases (e.g., a range where the particle size is 15 nm or smaller), it has been found that changes in particle size from the particle generator to the particle number measurement device significantly affect measurement results. Accordingly, the calibration apparatus 1 for a particle number measurement device in the present embodiment includes a particle size distribution measurement unit 33 (including a second particle classifier 34 and a particle counter 35), a physical quantity factor detection unit 40, a control unit 50, and other components, as described below, to enable more accurate calibration of the particle number measurement device 31.

The particle size distribution measurement unit 33 detects the particle size distribution of particles reaching the particle detection unit 30. In the present embodiment, the particle size distribution measurement unit 33 includes a second particle classifier 34 and a particle counter (particle counting unit) 35. The second particle classifier 34 classifies the particles reaching the particle size distribution measurement unit sequentially for each particle size. Each of the classified particles is sent to the particle counter 35 on the downstream side. The particle counter 35 is connected downstream of the second particle classifier 34, and counts the particles classified by the second particle classifier 34. By sequentially changing the particle size of particles counted by the second particle classifier 34 and the particle counter 35 in collaboration, and counting the number of particles at each particle size, a particle size distribution indicating the distribution of the particle sizes can be obtained. Information obtained from the second particle classifier 34 and the particle counter 35, or information related to the particle size distribution, is sent to the control unit 50 (input unit 51). In the present embodiment, the particle counter 35 is a CPC with a smaller cut-off size (i.e., a CPC with higher counting sensitivity for nanoparticles) than the particle number measurement device 31 serving as a calibration target.

Flow paths F1 through F5 are formed between the particle generator 10 and the particle detection unit 30, as well as between the second particle classifier 34 and the particle counter 35. Specifically, the flow path F1 connects the particle generator 10 and the first particle classifier 20. The flow path F2 connects the first particle classifier 20 and the particle number measurement device 31. The flow path F3 connects the first particle classifier 20 and the reference device 32. The flow path F4 connects the first particle classifier 20 and the second particle classifier 34. The flow path F5 connects the second particle classifier 34 and the particle counter 35. The flow paths F2, F3, and F4 are configured to have equivalent changes in particle size. For example, the flow paths F2, F3, and F4 may be configured to have the same inner diameter and tube length, or may be configured to have the same residence time of fluids flowing therein.

The physical quantity factor detection unit 40 detects or receives an input of physical quantity factors for changes in particle size, and transmits the detection results to the calculation unit 52. The physical quantity factors for changes in particle size include, for example, the temperature, humidity, pressure, flow rate, and/or residence time of a fluid in each of the flow paths from the first particle classifier 20 to the particle detection unit 30. The physical quantity factors may also include the tube length and/or inner diameter of each of the flow paths from the first particle classifier 20 to the particle detection unit 30.

The control unit 50 includes an input unit 51, a calculation unit 52, and a correction instruction unit 53. The control unit 50, which includes the input unit 51, the calculation unit 52, and the correction instruction unit 53, can be implemented by installing and executing a calibration program (computer program) on a computer device. The control unit 50 may be a general-purpose smartphone, tablet device, or laptop computer, or may be a dedicated computer specialized for the calibration apparatus 1 for a particle number measurement device. In the present invention, the term “computer device” refers to an information processing device equipped with a control unit, a storage device, and other components. By executing the calibration program, the control unit 50 is capable of implementing a method of determining and calibrating a calibration particle size used for calibrating the particle number measurement device 31.

The input unit 51 receives an input of a target particle size from a user P or others. The input unit 51 is capable of receiving, from the user or others, a detection efficiency function that indicates the detection efficiency of the particle number measurement device 31 serving as a calibration target, for each particle size. The function input to the input unit 51 may be, for example, a function derived from the curve illustrated in FIG. 2. Alternatively, the function (a detection efficiency function using the particle size as a variable) may be input as a data set representing the curve illustrated in FIG. 2. By receiving the function, the calculation unit 52 maps: the detection efficiency measurement results without shrinkage correction (feedback from the particle size distribution measurement unit) onto the vertical axis; and the particle size data from the particle size distribution measurement unit onto the horizontal axis, thereby allowing for estimating the detection efficiency at the target particle size. Furthermore, the input unit 51 is capable of receiving an input of data related to the particle size distribution detected by the particle size distribution measurement unit 33. The input unit 51 may receive an input via a pointing device such as a mouse, keyboard, or touch panel, or may receive an input by communicating over an external network. The information input to the input unit 51 is transmitted to the calculation unit 52.

The calculation unit 52 determines a degree of change in particle size relative to the target particle size for each of the particles that have reached the particle detection unit 30, based on the information input into the input unit 51, the information obtained from the physical quantity factor detection unit 40, and the particle size distribution detected by the particle size distribution measurement unit. In the present embodiment, since liquid particles shrink in particle size due to evaporation, the degree of change is represented by a degree of shrinkage in particle size. The calculated degree of change (shrinkage) may be expressed as a ratio or as a difference value. Furthermore, based on the calculated degree of change, the calculation unit 52 determines a correction amount in particle size for particles to be extracted by the first particle classifier 20, such that particle sizes of particles reaching the particle detection unit 30 match the target particle size. The phrase “such that particle sizes of particles reaching the particle detection unit 30 match the target particle size” does not refer to only the case where the particle sizes of the particles reaching the particle detection unit 30 completely match the target particle size. Specifically, the phrase also includes cases where the correction amount is calculated, such that the particle sizes of the particles reaching the particle detection unit 30 are sufficiently close to, and thus considered equivalent to, the target particle size. The correction amount calculated by the calculation unit 52 is transmitted to the correction instruction unit 53. The calculation unit 52 also calculates the detection efficiency at the target particle size achieved by the particle number measurement device 31 using the particle size distribution detected by the particle size distribution measurement unit 33.

The correction instruction unit 53 instructs the first particle classifier 20 to change the particle sizes of the particles classified and extracted by the first particle classifier 20 into a calibration particle size, based on the correction amount calculated by the calculation unit 52. The above-mentioned calibration particle size reflects the amount of change in particle size relative to the target particle size, over the course of being classified and extracted by the first particle classifier 20 and reaching the particle detection unit 30. In other words, the calibration particle size is set in the first particle classifier 20, such that the particle sizes of the particles reaching the particle detection unit 30 match or closely approximate the target particle size. As described earlier, the first particle classifier 20 extracts (classifies) only particles of a particle size commensurate to the voltage applied to the classification tube. Therefore, the correction instruction unit 53 instructs the first particle classifier 20 to change the voltage applied to the classification tube of the first particle classifier 20 to a voltage for extracting (classifying) particles of the calibration particle size.

In the present embodiment, in which liquid particles shrink in particle size due to evaporation, the calibration particle size is set larger than the target particle size in order to compensate for shrinkage. For example, in order to calibrate the particle number measurement device 31 at a particle size of 10 nm, suppose that the first particle classifier 20 classifies and extracts particles of the target particle size of 10 nm, and the shrink in particle size to 9.8 nm by the time the particles reach the particle detection unit 30. In this case, a difference value of −0.2 nm, or a change rate of 98%, can be obtained as the degree of change in outer diameter. The correction instruction unit 53 sets a calibration particle size, such that the particle sizes of the particles reaching the particle detection unit 30 are 10 nm or a value very close to 10 nm. In this case, the calibration particle size may be set to 10.2 nm. However, in the case where the degree of shrinkage due to evaporation is expected to vary depending on the particle size, the calibration particle size may be set to a value that takes this effect into account. The calculation unit 52 and the correction instruction unit 53 execute the above operations, whereby the calibration apparatus 1 of the present embodiment can execute more accurate calibration.

The calibration apparatus 1 may also generate non-shrinking solid particles (e.g., sucrose particles) using the particle generator 10, extract 10 nm sucrose particles using the particle classifier 20, and measure them with the particle size distribution measurement unit 33. This operation can verify and adjust the accuracy of particle size measurement affected by variations in particle transport time between the second particle classifier 34 and the particle counter 35 in the particle size distribution measurement unit 33.

With the above configuration, the calibration apparatus 1 of the present embodiment enables more accurate calibration than conventional cases. In addition to executing correction, it is also desirable to suppress changes in particle size of particles reaching the particle detection unit 30 from the first particle classifier 20. The shrinkage in particle size due to evaporation primarily occurs within all the flow paths F1, F2, F3, F4, and F5. Accordingly, the time during which the particles reside (pass) in these flow paths (hereinafter referred to as “residence time”) is considered to be closely related to the evaporation time of the particles. Therefore, an experiment was conducted to investigate the relationship between particle residence time and particle shrinkage by preparing a plurality of combinations of the inner diameter and tube length for the pre-classification flow path F1 and the post-classification flow path F4. All of the flow paths used in this experiment have a circular tube structure.

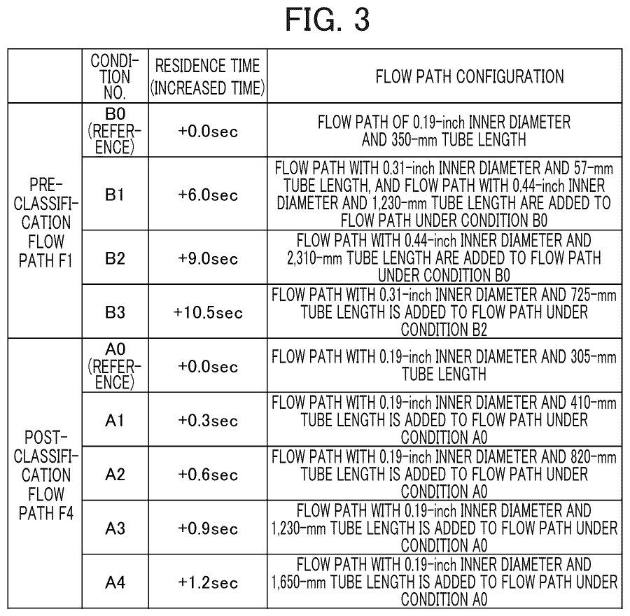

FIG. 3 is a table summarizing the flow path configurations of the pre-classification flow path F1 and the post-classification flow path F4, which were used in an experiment to investigate the relationship between particle residence time and particle shrinkage in the flow paths. The pre-classification residence times in the flow path F1 were set to be incrementally extended as follows: condition B0: +0.0 sec (baseline condition), condition B1: +6.0 sec, condition B2: +9.0 sec, and condition B3: +10.5 sec. The actual pre-classification residence time under the condition B0 (+0.0 sec) was 0.26 sec. The specific configuration of the flow path F1 is as illustrated in FIG. 3. The post-classification residence times in the flow path F4 were set to be incrementally extended as follows: condition A0: +0.0 sec (baseline condition), condition A1: +0.3 sec, condition A2: +0.6 sec, condition A3: +0.9 sec, and condition A4: +1.2 sec. The specific configuration of the flow path F4 is as illustrated in FIG. 3. The actual post-classification residence time under the condition A0 (+0.0 sec) was 0.22 sec. By combining four variations of the pre-classification flow path F1 and five variations of the post-classification flow path F4, the particle size distribution measurement unit 33 was used for determining the particle size distribution for each combination, and changes in particle size of the particles reaching the particle detection unit 30 were checked. A particle size to be classified and extracted by the first particle classifier 20 was set to 10 nm.

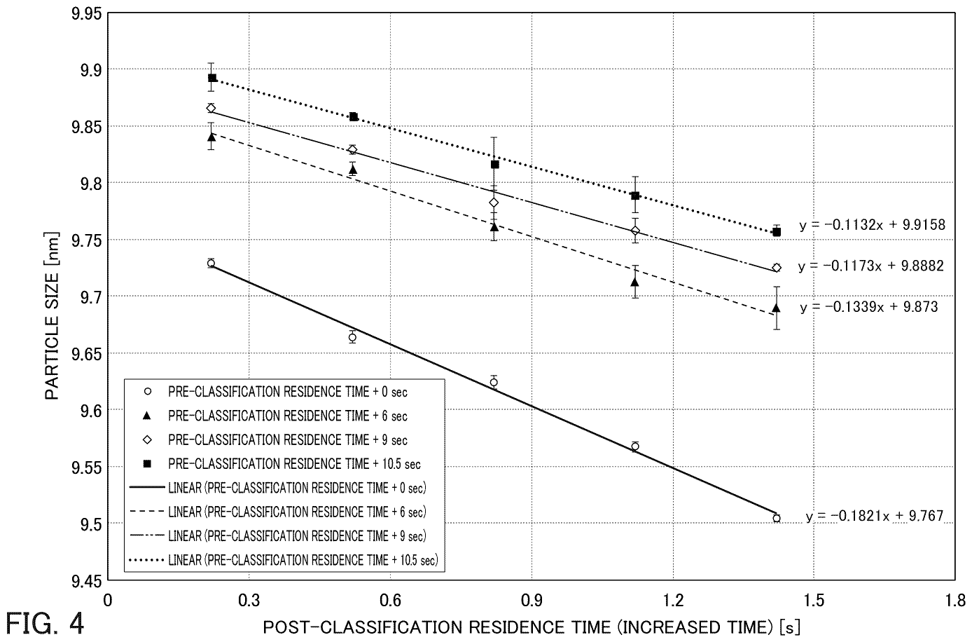

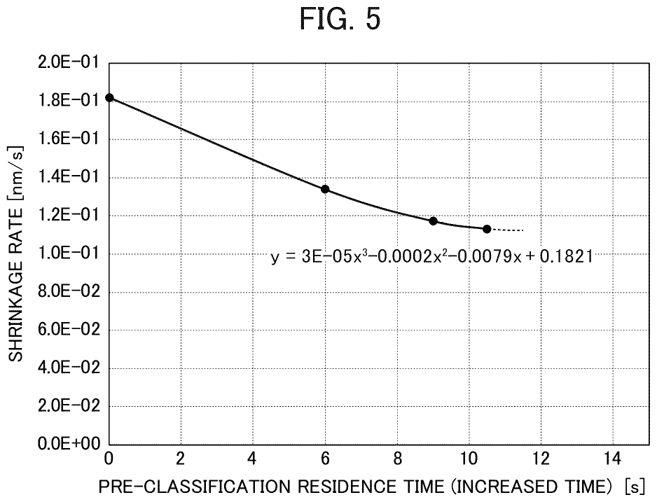

FIG. 4 is a graph plotting the effect of post-classification residence time on particle sizes of the particles reaching the particle detection unit 30 for each pre-classification residence time. The vertical axis in FIG. 4 represents the geometric mean diameter (GMD). As illustrated in FIG. 4, the particle size decreases as the post-classification residence time increases. It can also be understood that as the pre-classification residence time increases, both of the shrinkage rate (slope) and the shrinkage amount (intercept) decrease, which indicates reduction in shrinkage. In order to further clarify the effect of pre-classification residence time, the relationship between pre-classification residence time and shrinkage rate was examined. FIG. 5 is a graph illustrating the effect of pre-classification residence time on the shrinkage rate. As understood in view of FIG. 5, the shrinkage rate begins to stabilize when the pre-classification residence time exceeds approximately +8 seconds relative to the baseline (+0 sec), and the shrinkage rate is fairly stable at +10 seconds or more. Therefore, in the present embodiment, the pre-classification flow path F1 was set as an evaporation flow path to promote evaporation in advance, allowing for expecting the effect of increasing the pre-classification residence time in FIG. 5 by approximately +8 seconds. By securing an appropriate pre-classification residence time in the evaporation flow path, post-classification shrinkage of particle size can be suppressed.

The effect of increasing the pre-classification residence time by approximately +8 seconds is observed between 6-second and 9-second increases in the pre-classification residence time. In view of FIG. 4, it can be confirmed that the rate of reduction in particle size due to component evaporation from the particle surface remains below 3% in a region (where the particle size is at least 9.7 nm) in the flow paths F2, F3, and F4 from the first particle classifier 20 to the particle detection unit 30. Specifically, the flow path F1 from the particle generator 10 to the first particle classifier 20 is formed as an evaporation flow path where component evaporation from the particle surface occurs in advance, such that the rate of reduction in particle size due to component evaporation from the particle surface remains below 3% in the flow paths F2, F3, and F4 from the first particle classifier 20 to the particle detection unit 30. However, when the pre-classification residence time is increased by using the flow path F1 as an evaporation flow path, some particles may adhere to the walls of the flow path, which may reduce the number of particles obtained. Therefore, in the present embodiment, as previously described, the solvent used for diluting poly alpha-olefin consists of 100% ethanol by weight, and the ethanol contains an appropriate amount of electrolyte (e. g., ammonium acetate) to increase the number of particles generated by the particle generator 10.

Referring to FIG. 4, even if sufficient component evaporation occurs in advance in the flow path F1 from the particle generator 10 to the first particle classifier 20, further shrinkage of particle size may occur if the post-classification residence time is prolonged (increased). Therefore, the residence time (post-classification residence time) of particles should preferably be shortened to the extent possible in the flow paths F2, F3, and F4 from the first particle classifier 20 to the particle detection unit 30. In order to accurately measure the particle size at the inlet of the particle number measurement device 31 serving as a calibration target, the shrinkage in particle size, i.e., the residence time, should preferably be consistent in the flow paths F2, F3, and F4. For example, in order to reduce the shrinkage to less than 0.1 nm, the residence time in the flow paths F2, F3, and F4 from the first particle classifier 20 to the particle detection unit 30 should preferably be less than 1 second.

### Method of Determining and Calibrating Calibration Particle Size

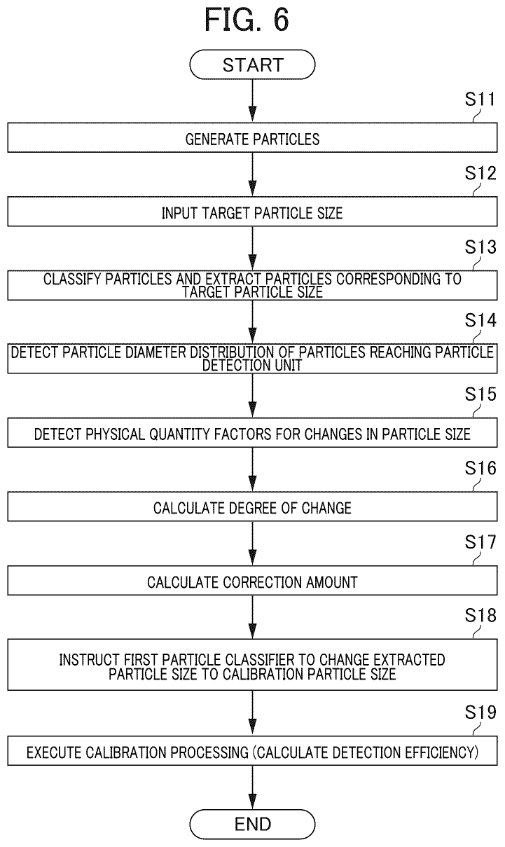

FIG. 6 is a flowchart illustrating the operational flow when executing a method of determining and calibrating a calibration particle size, primarily executed by the control unit 50.

In Step S11, the particle generator 10 generates particles. In Step S12, the input unit 51 receives an input of a target particle size from a user. In Step S13, the first particle classifier 20 classifies particles generated by the particle generator 10, and extracts particles corresponding to the target particle size received via the input unit 51.

In Step S14, the particle size distribution measurement unit 33 in the particle detection unit 30 detects a particle size distribution of the particles classified by the first particle classifier 20 and reaching the particle detection unit 30.

In Step S15, the physical quantity factor detection unit 40 detects physical quantity factors for changes in particle size. The physical quantity factors include, for example, temperature, humidity, and atmospheric pressure.

In Step S16, the calculation unit 52 determines a degree of change in particle size relative to the target particle size for each of the particles that have reached the particle detection unit 30, based on the physical quantity factors obtained by the physical quantity factor detection unit 40 and the particle size distribution obtained by the particle size distribution measurement unit 33.

In Step S17, the calculation unit 52 calculates a correction amount for a particle size to be extracted by the first particle classifier 20, such that particle sizes of particles reaching the particle detection unit 30 match the target particle size.

In Step S18, the correction instruction unit 53 instructs the first particle classifier 20 to change the particle sizes of the particles to be extracted by the first particle classifier 20 into a calibration particle size, based on the correction amount calculated by the calculation unit 52.

In Step S19, the reference device 32 and the particle number measurement device 31 perform counting with the particles classified and extracted by the first particle classifier 20 based on the particle sizes changed into the calibration particle size, thereby calculating the detection efficiency, i.e., executing the calibration operations at the target particle size.

By executing the above operations for each required target particle size, the calibration operations of the particle number measurement device 31 are completed.

### Example

A calibration apparatus 1 according to the present embodiment including the above configuration was actually fabricated and compared with a conventional calibration apparatus. The comparison results will be described below. In the calibration apparatus 1 of the embodiment, a pre-classification flow path F1 was set under a condition BO in FIG. 3, allowing for sufficient pre-classification evaporation. Post-classification flow paths F2 to F4 were set under a condition A0 in FIG. 3 to suppress a reduction in particle size due to post-classification evaporation. A Comparative Example was configured as the same as the Example, except that correction operations were not conducted by a control unit 50. The evaluated particle sizes (target particle sizes) included eight different values: 7 nm, 8 nm, 9.8 nm, 10 nm, 10.2 nm, 11 nm, 13 nm, and 15 nm.

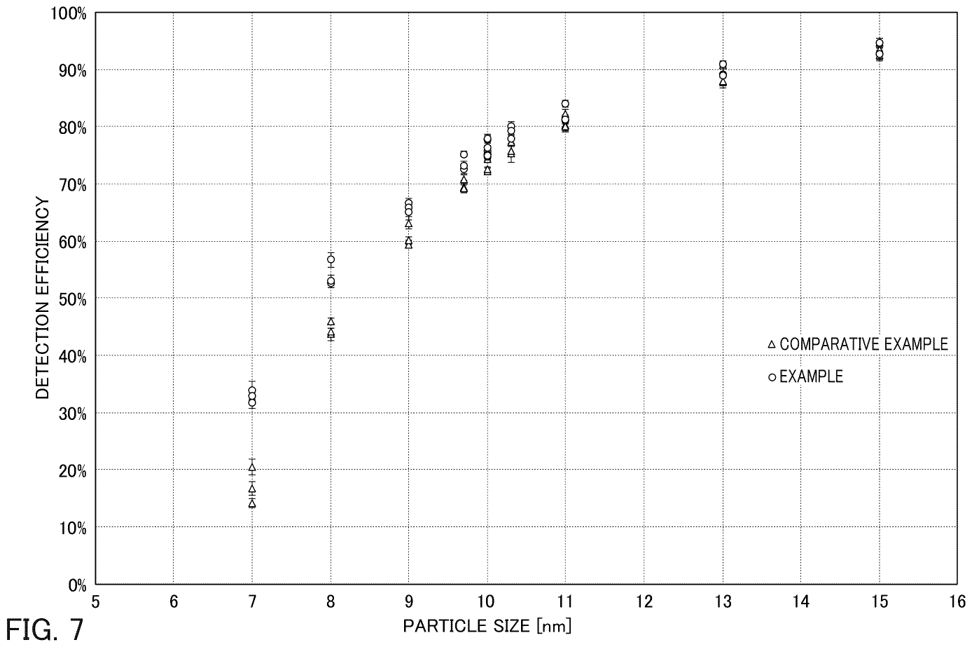

FIG. 7 is a graph summarizing the detection efficiency determined for each particle size in both the Example and the Comparative Example. As illustrated in FIG. 7, the calibration operation was executed by determining the detection efficiency for each target particle size serving as a target. By accurately determining the detection efficiency, the actual particle number can be correctly obtained based on the count results of the corresponding particle size and the detection efficiency. As illustrated in FIG. 7, differences between the Example and the Comparative Example were observed at particle sizes of 10 nm or smaller, and the detection efficiency was higher in the Example conducting correction than in the Comparative Example without conducting correction. This is considered to be because the calibration operation in the Comparative Example was conducted by measuring the detection sensitivity at a particle size reduced to be smaller than the target particle size. In contrast, the measurement results of the Example reflect the detection sensitivity at the target particle size, allowing for exact measurement of detection sensitivity and enabling higher-accuracy calibration.

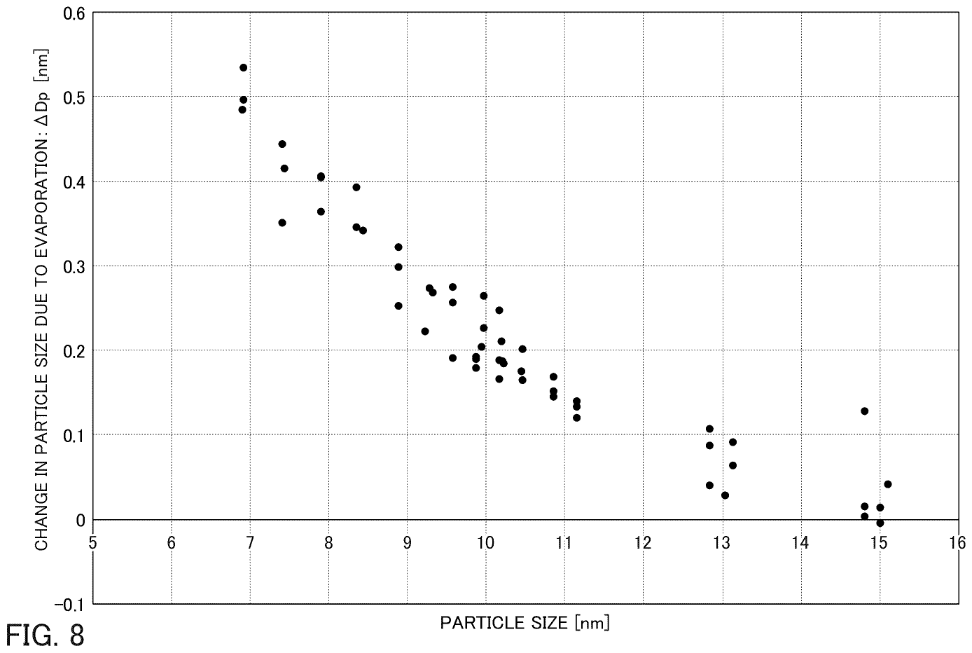

FIG. 8 is a graph plotting a change in particle size ΔDp (nm) due to evaporation, calculated as the difference between a classified particle size and a measured particle size, for each measured particle size. The data of FIG. 8 are collectively illustrated without distinguishing between the Example and the Comparative Example illustrated in FIG. 7. This is because, although the Example conducted correction, there was no difference between the Example and the Comparative Example in terms of post-classification changes in particle size. The horizontal axis in FIG. 8 represents the particle size input into the first particle classifier 20. Accordingly, the following relationship holds: (particle size input into the first particle classifier 20: horizontal axis)−(ΔDp: vertical axis)≈(approximately equal) particle size measured by the particle size distribution measurement unit 33. FIG. 8 indicates that the change in particle size is negligible at a particle size of 15 nm (ΔDp≈0), and the amount of shrinkage increases as the particle size decreases. It was confirmed that particles smaller than 15 nm are more susceptible to shrinkage, and failure to correct the shrinkage may result in discrepancies in measurement results of the detection sensitivity.

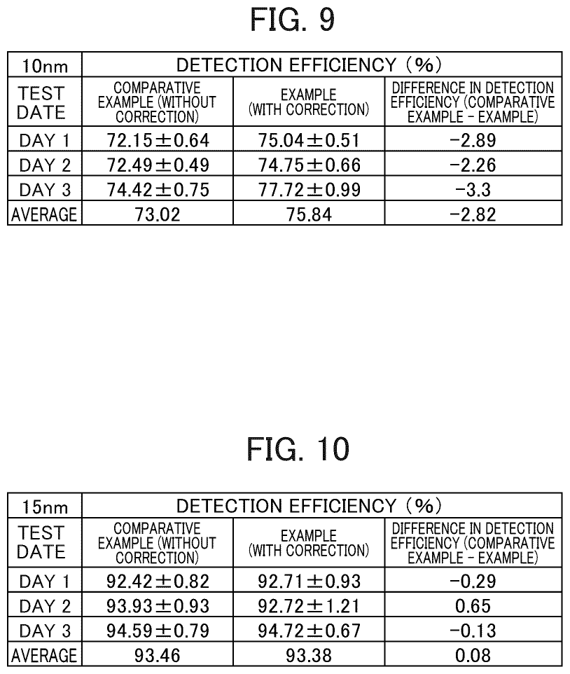

Among the dataset illustrated in FIG. 7, numerical data for particle sizes of 10 nm and 15 nm were compiled into tables, as illustrated in FIGS. 9 and 10. FIG. 7 illustrates each data along with the averaged data of the measurements conducted over three days. FIG. 9 illustrates the difference in detection efficiency at a particle size of 10 nm between the Comparative Example and the Example. FIG. 10 illustrates the difference in detection efficiency at a particle size of 15 nm between the Comparative Example and the Example. It can be understood that a detection sensitivity difference of −2.82 points is observed at a particle size of 10 nm in view of the numerical values in FIG. 9, whereas little detection sensitivity difference is observed over the three-day period at a particle size of 15 nm in view of the numerical values in FIG. 10.

As described above, the calibration apparatus 1 of the first embodiment actually measures the degree of change in particle size for each of the particles reaching the particle detection unit 30 after classification by the first particle classifier 20, and the particle size classified and extracted by the first particle classifier 20 is corrected based on the results of measurement. Therefore, it is possible to compensate for the reduction in calibration accuracy caused by the shrinkage in particle size due to evaporation, which is particularly significant for extremely small particle sizes such as approximately 10 nm, thereby enabling higher-accuracy calibration. Since an evaporation flow path is provided in the flow path F1 from the particle generator 10 to the first particle classifier 20 to allow for sufficient component evaporation in advance, it is possible to reduce the degree of change in particle size for each of the particles reaching the particle detection unit 30 after classification by the first particle classifier 20, thereby lowering the calibration error that may occur before correction. According to the calibration apparatus 1 of the present embodiment, it is possible to address the occurrence of calibration errors in the detection sensitivity of 10 nm particles, which may arise due to the introduction of new regulations for automotive exhaust particles in Europe, and to optimize the calibration. According to the calibration apparatus 1 of the present embodiment, by measuring the shrinkage in particle size due to the evaporation of PAO, which is the component of calibration particles in the calibration apparatus 1, it is possible to correct the impact due to the shrinkage on detection sensitivity calibration and achieve highly reproducible calibration, accordingly.

### Second Embodiment

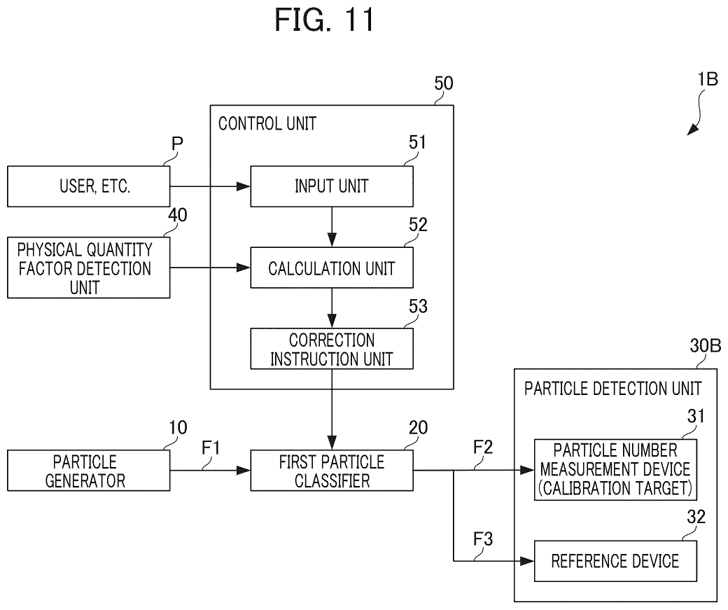

FIG. 11 is a block diagram illustrating the configuration of a calibration apparatus 1B for a particle number measurement device according to a second embodiment. The calibration apparatus 1B of the second embodiment differs from the calibration apparatus 1 of the first embodiment in that a particle detection unit 30B does not include an element corresponding to the particle size distribution measurement unit 33 of the first embodiment. Since other features are similar to those of the calibration apparatus 1 of the first embodiment, components serving the same functions as in the first embodiment are denoted with the same reference numerals, and redundant descriptions are omitted as appropriate.

Since the calibration apparatus 1B of 44 the second embodiment does not include the element corresponding to the particle size distribution measurement unit 33 of the first embodiment, a calculation unit 52 determines a degree of change in particle size relative to a target particle size for each of the particles that have reached a particle detection unit 30B, based on information from a physical quantity factor detection unit 40. Here, since measurement results of the particle sizes of the particles having actually reached the particle detection unit 30B are not available, the calculation unit 52 in the second embodiment may determine a residence time for each of the particles, based on pre-entered information on flow paths F1, F2, and F3 in the calibration apparatus 1B, or based on the input received via an input unit 51. Alternatively, the residence time for each of the particles may be detected or input as a physical quantity factor. The calculation unit 52 pre-stores data related to particle shrinkage, as illustrated in FIGS. 4 and 5. Based on such information, the calculation unit 52 determines the degree of change in particle size relative to the target particle size for each of the particles that have reached the particle detection unit 30. The subsequent operations are the same as those in the first embodiment.

According to the calibration apparatus 1B of the second embodiment, it is possible to execute high-accuracy calibration with a simpler configuration. Since the measurement operations using the particle size distribution measurement unit 33 are unnecessary, the calibration operations can be executed more easily.

### Modifications

The embodiments described above are not limited thereto, and various modifications and changes can be made, all of which are also within the scope of the present disclosure.

The first embodiment has been described as an example in which the calculation unit 52 determines the degree of change in particle size relative to the target particle size for each of the particles that have reached the particle detection unit 30, using information from both the physical quantity factor detection unit 40 and the particle size distribution measurement unit 33. However, the present disclosure is not limited thereto. For instance, the calculation unit 52 may determine the degree of change in particle size relative to the target particle size for each of the particles that have reached the particle detection unit 30, without using physical quantity factors. In this case, the physical quantity factor detection unit 40 may be omitted.

In both the first and second embodiments, the physical quantity factor detection unit 40 may be omitted. In such a case, the physical quantity factors may be input via the input unit 51, or may be pre-calculated or pre-stored.

In the second embodiment, instead of calculating the degree of shrinkage in particle size from the physical quantity factors, pre-calculated degree of shrinkage in particle size may be used, provided that the physical quantity factors remain the same. In such a case, the physical quantity factor detection unit 40 may be omitted.

In both the first and second embodiments, in a case where the length of and/or the residence time in the flow path F1 from the particle generator 10 to the first particle classifier 20 is adjusted to allow for sufficient component evaporation in advance, shrinkage in particle size hardly occurs at all after passing through the first particle classifier 20. In such a case, the calibration apparatus 1 may not need to include some or all components of the control unit 50. Specifically, the calibration apparatus may be configured to include the particle generator 10, the flow path F1 with the residence time adjusted to allow for sufficient component evaporation in advance, the first particle classifier 20, and the particle detection unit 30 (30B).

Each embodiment has been described for an example case where the particle size shrinks. However, the present disclosure is not limited thereto, and the calibration apparatus of the present invention can also be used in cases where the particle size expands.

### EXPLANATION OF REFERENCE CHARACTERS

1, 1b: calibration apparatus
10: particle generator
20: first particle classifier
30, 30B: particle detection unit
31: particle number measurement device
32: reference device
33: particle size distribution measurement unit
34: second particle classifier
35: particle counter
40: physical quantity factor detection unit
50: control unit
51: input unit
52: calculation unit
53: correction instruction unit
F1-F5: flow path

1. A calibration apparatus for use in calibrating a particle number measurement device, the apparatus comprising:
a particle generation unit configured to generate particles;
an input unit configured to receive an input of a target particle size;
a particle classification unit configured to classify the particles generated by the particle generation unit and extract particles corresponding to the target particle size received via the input unit;
a particle detection unit configured to detect the particles extracted by the particle classification unit;
a calculation unit configured to determine a degree of change in particle size relative to the target particle size for each of the particles that have reached the particle detection unit, based on a physical quantity factor for a change in particle size at the particle detection unit or a particle size distribution of the particles at the particle detection unit, and to calculate a correction amount for particle sizes of particles to be extracted by the particle classification unit, such that the particle sizes of the particles reaching the particle detection unit match the target particle size; and
a correction instruction unit configured to instruct the particle classification unit to change the particle sizes of the particles to be extracted by the particle classification unit into a calibration particle size, based on the correction amount calculated by the calculation unit.

2. The calibration apparatus for a particle number measurement device according to claim 1, further comprising:
a physical quantity factor detection unit configured to detect the physical quantity factor, wherein
the calculation unit is configured to calculate the correction amount using at least the physical quantity factor obtained by the physical quantity factor detection unit.

3. The calibration apparatus for a particle number measurement device according to claim 1, wherein
the particle detection unit includes a particle size distribution measurement unit configured to detect a particle size distribution of the particles reaching the particle detection unit, and
the calculation unit is configured to calculate the correction amount using the particle size distribution detected by the particle size distribution measurement unit.

4. The calibration apparatus for a particle number measurement device according to claim 1, wherein
the physical quantity factor includes at least one of a temperature, humidity, pressure, flow rate, or residence time of a fluid in a flow path from the particle classification unit to the particle detection unit.

5. The calibration apparatus for a particle number measurement device according to claim 3, wherein
the particle size distribution measurement unit includes:
a second particle classification unit configured to classify the particles reaching the particle size distribution measurement unit; and
a particle counting unit configured to connect downstream of the second particle classification unit and count a particle number of the particles classified by the second particle classification unit.

6. The calibration apparatus for a particle number measurement device according to claim 3, wherein
the input unit is configured to receive a detection efficiency function representing a detection efficiency per particle size for the particle number measurement device serving as a calibration target, and
the calculation unit is configured to calculate a detection efficiency at the target particle size achieved by the particle number measurement device serving as a calibration target, using the particle size distribution detected by the particle size distribution measurement unit.

7. The calibration apparatus for a particle number measurement device according to claim 1, wherein
the correction instruction unit is configured to instruct the particle classification unit to change a voltage applied to a classification tube provided in the particle classification unit.

8. The calibration apparatus for a particle number measurement device according to claim 1, wherein
the particles generated by the particle generation unit contain poly alpha-olefin as a main component, and
a solvent used for diluting the poly alpha-olefin has an ethanol content of 50% or more by weight.

9. The calibration apparatus for a particle number measurement device according to claim 1, wherein
a flow path from the particle generation unit to the particle classification unit is an evaporation flow path where component evaporation from a particle surface occurs in advance, such that a rate of reduction in particle size due to the component evaporation from the particle surface is less than 3% in a flow path from the particle classification unit to the particle detection unit.

10. A non-transitory computer-readable storage medium storing a calibration program for use in calibrating a particle number measurement device, the program causing a computer to execute the steps of:
causing a particle generation unit to generate particles;
causing an input unit to receive an input of a target particle size from a user;
causing a particle classification unit to classify the particles generated by the particle generation unit and extract particles corresponding to the target particle size received via the input unit;
causing a particle detection unit to detect the particles extracted by the particle classification unit;
causing a calculation unit to determine a degree of change in particle size relative to the target particle size for each of the particles that have reached the particle detection unit, based on a physical quantity factor for a change in particle size at the particle detection unit, or a particle size distribution of the particles at the particle detection unit, and calculate a correction amount for particle sizes of particles to be extracted by the particle classification unit, such that the particle sizes of the particles reaching the particle detection unit match the target particle size; and
causing a correction instruction unit to instruct the particle classification unit to change the particle sizes of the particles to be extracted by the particle classification unit into a calibration particle size, based on the correction amount calculated by the calculation unit.

11. The storage medium according to claim 10, further comprising the step of:
causing a physical quantity factor detection unit to detect the physical quantity factor, wherein
the calculation unit is configured to calculate the correction amount using at least the physical quantity factor obtained by the physical quantity factor detection unit.

12. The storage medium according to claim 10, further comprising:
causing a particle size distribution measurement unit to detect a particle size distribution of the particles reaching the particle detection unit, wherein
the calculation unit is configured to calculate the correction amount using the particle size distribution detected by the particle size distribution measurement unit.

13. A method of determining a calibration particle size for use in calibrating a particle number measurement device, the method comprising the steps of:
causing a particle generation unit to generate particles;
causing an input unit to receive an input of a target particle size from a user;
causing a particle classification unit to classify the particles generated by the particle generation unit and extract particles corresponding to the target particle size received via the input unit;
causing a particle detection unit to detect the particles extracted by the particle classification unit;
causing a calculation unit to determine a degree of change in particle size relative to the target particle size for each of the particles that have reached the particle detection unit, based on a physical quantity factor for a change in particle size at the particle detection unit, or a particle size distribution of the particles at the particle detection unit, and calculate a correction amount for particle sizes of particles to be extracted by the particle classification unit, such that the particle sizes of the particles reaching the particle detection unit match the target particle size; and
causing a correction instruction unit to instruct the particle classification unit to change the particle sizes of the particles to be extracted by the particle classification unit into a calibration particle size, based on the correction amount calculated by the calculation unit.

14. The method of determining a calibration particle size according to claim 13, further comprising the step of:
causing a physical quantity factor detection unit to detect the physical quantity factor, wherein
the calculation unit is configured to calculate the correction amount using at least the physical quantity factor obtained by the physical quantity factor detection unit.
15. The method of determining a calibration particle size according to claim 13, further comprising the step of:
causing a particle size distribution measurement unit to detect a particle size distribution of the particles reaching the particle detection unit, wherein
the calculation unit is configured to calculate the correction amount using the particle size distribution detected by the particle size distribution measurement unit.

16. A method of calibrating a particle number measurement device, the method comprising:
causing the particle classification unit to extract particles based on the calibration particle size determined by the method of determining a calibration particle size according to claim 13; and
calibrating the particle number measurement device serving as a calibration target using the particles of the calibration particle size extracted by the particle classification unit.
